(19) United States
(12) Patent Application Publication
(10) Pub. No.: US 2026/0260802 A1
(43) Pub. Date: Sep. 3, 2026

(54) COIL UNIT

(71) Applicant: DENSO CORPORATION, Kariya-city (JP)

(72) Inventors: Eisuke TAKAHASHI, Kariya-city (JP); Makoto OTSUBO, Kariya-city (JP)

(73) Assignee: DENSO CORPORATION, Kariya-city (JP)

(21) Appl. No.: 19/657,213

(22) Filed: Apr. 24, 2026

Related U.S. Application Data
(63) Continuation of application No. PCT/JP2024/041428, filed on Nov. 22, 2024.

(30) Foreign Application Priority Data
Dec. 8, 2023 (JP) 2023-207670

(51) Int. Cl. H01F 27/10; H01F 27/02; H01F 27/28; H02J 50/00

(52) U.S. Cl. CPC H01F 27/10; H01F 27/025; H01F 27/28; H02J 50/005

(57) ABSTRACT

Disclosed is a coil unit for use in a wireless power transfer system. The coil unit includes: a base plate; a cover that forms a sealed space between the cover and the base plate; a magnetic plate placed on the base plate within the sealed space; a coil configured to transmit or receive AC power, the coil being placed on the magnetic plate in a stacking direction within the sealed space, the stacking direction being a direction in which the base plate, the magnetic plate and the coil are stacked; and a fluid material having fluidity and encapsulated in the sealed space.

### CROSS-REFERENCE TO RELATED APPLICATIONS

The present application is a continuation application of International Application No. PCT/JP2024/041428 filed on November 22, 2024, which is based on and claims priority from Japanese Patent Application No. 2023-207670 filed on December 8, 2023. The entire contents of these applications are incorporated by reference into the present application.

### BACKGROUND

### 1 TECHNICAL FIELD

The present disclosure relates to coil units.

### 2 DESCRIPTION OF RELATED ART

Coil units have been known which are employed in wireless power transfer systems (or contactless power supply systems) that transmit electric power from a power transmission device, thereby supplying electric power to a vehicle equipped with a power reception device. Moreover, there is disclosed, for example in Japanese Unexamined Patent Application Publication No. JP 2017-038436 A, a coil unit in which: devices are accommodated in a device accommodation space defined by a base and a protective cover; and external forces applied to the protective cover are borne by the devices abutting the protective cover, thereby suppressing deformation of the protective cover.

### SUMMARY

However, in the coil unit disclosed in the aforementioned patent document, the devices may be damaged by the external forces applied thereto. Moreover, when an external force is applied to a part of the protective cover which does not abut against any of the devices, the part of the protective cover may be deformed by the external force. Therefore, there is a demand for a technique that enables both suppression of deformation of the devices accommodated within the protective cover and suppression of deformation of the protective cover.

The present disclosure has been accomplished in view of the above circumstances.

According to the present disclosure, there is provided a coil unit for use in a wireless power transfer system (or contactless power supply system). The coil unit includes: a base plate; a cover that forms a sealed space between the cover and the base plate; a magnetic plate placed on the base plate within the sealed space; a coil configured to transmit or receive AC power, the coil being placed on the magnetic plate in a stacking direction within the sealed space, the stacking direction being a direction in which the base plate, the magnetic plate and the coil are stacked; and a fluid material having fluidity and encapsulated in the sealed space.

The coil unit according to the present disclosure has the fluid material encapsulated in the sealed space. Therefore, when the cover is deformed by an external force applied thereto, the volume of the sealed space decreases, increasing the pressure of the fluid material within the sealed space; thus, a force acts from the inside of the cover to resist the decrease in the volume of the sealed space. Consequently, it becomes possible to suppress deformation of the cover due to the external force while preventing the external force from being locally applied to the devices accommodated in the sealed space and thereby causing deformation of the devices.

### BRIEF DESCRIPTION OF THE DRAWINGS

FIG. 1 is an explanatory diagram showing a schematic configuration of a wireless power transfer system according to a first embodiment.

FIG. 2 is an explanatory diagram showing a circuit configuration of the wireless power transfer system according to the first embodiment.

FIG. 3 is an exploded perspective view showing an internal configuration of a coil unit according to the first embodiment.

FIG. 4 is a plan view schematically showing the coil unit according to the first embodiment.

FIG. 5 is a cross-sectional view, taken along the line V-V in FIG. 4, schematically showing the coil unit according to the first embodiment.

FIG. 6 is an explanatory diagram showing a circuit configuration of a wireless power transfer system according to a second embodiment.

FIG. 7 is a plan view schematically showing a coil unit according to the second embodiment.

FIG. 8 is a cross-sectional view, taken along the line VI-VI in FIG. 7, schematically showing the coil unit according to the second embodiment.

FIG. 9 is a cross-sectional view schematically showing a coil unit according to a third embodiment.

FIG. 10 is an explanatory diagram showing a part of FIG. 9 in a magnified manner.

FIG. 11 is a cross-sectional view schematically showing a coil unit according to a fourth embodiment.

FIG. 12 is a cross-sectional view schematically showing a coil unit according to a fifth embodiment.

### DESCRIPTION OF EMBODIMENTS

### A. First Embodiment

### A1. Configuration of Wireless Power Transfer System 300

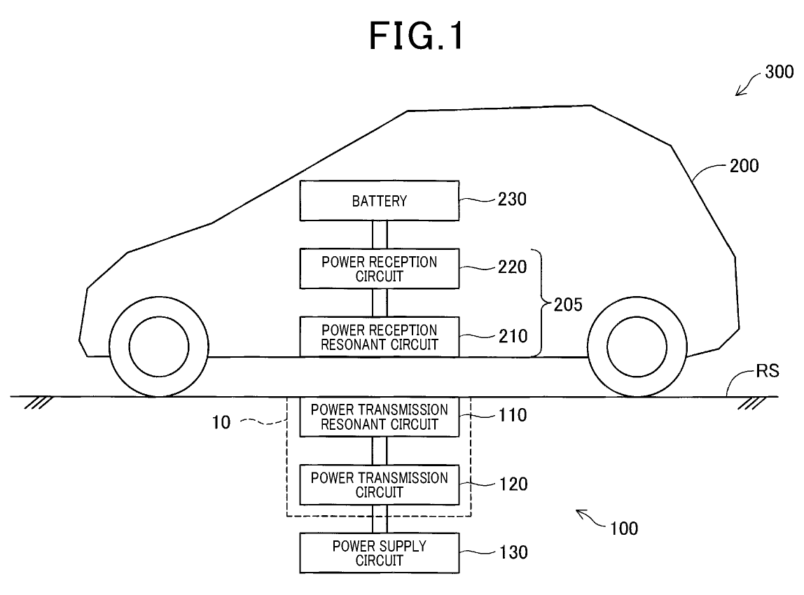

A coil unit 10 according to the first embodiment will be described with reference to FIGS. 1 to 5. The coil unit 10 is employed in a wireless power transfer system 300. As shown in FIG. 1, the wireless power transfer system 300 includes a power transmitter 100 installed in a road RS and a power receiver 205 mounted to a vehicle 200. The wireless power transfer system 300 is a system which can supply electric power from the power transmitter 100 to the power receiver 205 of the vehicle 200 in a wireless (or contactless) manner. In the present embodiment, the coil unit 10 is provided in the power transmitter 100.

In the present embodiment, the power transmitter 100 includes the coil unit 10 and a power supply circuit 130. The coil unit 10 includes a power transmission resonant circuit 110 and a power transmission circuit 120. Moreover, in the present embodiment, the coil unit 10 and the power supply circuit 130 are embedded in the road RS. It should be noted that: the power transmitter 100 may include a plurality of coil units 10; and the plurality of coil units 10 may be arranged, for example, continuously along the extending direction of the road RS which is the traveling direction of the vehicle 200. It also should be noted that: the coil unit 10 and the power supply circuit 130 are not necessarily embedded in the road RS; and they may alternatively be provided, for example on the road RS, at positions where they do not hinder the traveling of the vehicle 200. It is preferable for the power supply circuit 130 to be provided in the vicinity of the coil unit 10. In addition, the power transmission resonant circuit110 and the power transmission circuit 120 may be configured separately from the coil unit 10.

The power supply circuit 130 supplies AC power from an AC power source, such as a power grid, to the power transmission circuit 120 via a power cable. The power transmission circuit 120 is an AC conversion circuit which includes a rectifier circuit, an inverter circuit and a filter circuit. The power transmission circuit 120 converts the AC power supplied from the power supply circuit 130 into DC power, converts the DC power into high-frequency AC power that can be transmitted to the power receiver 205 of the vehicle 200, and supplies the high-frequency AC power to the power transmission resonant circuit110.

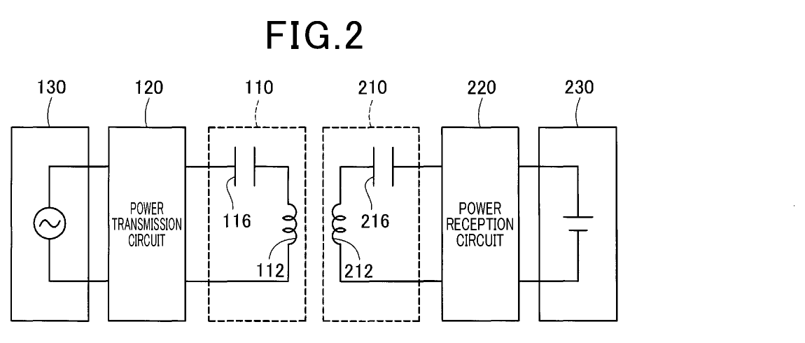

As shown in FIG. 2, the power transmission resonant circuit 110 is an LC circuit in which a transmission-side capacitor 116 functioning as a resonance capacitor and a power transmission coil 112 are connected in series with each other. It should be noted that the power transmission coil 112 and the transmission-side capacitor 116 may alternatively be connected in parallel with each other. The power transmission resonant circuit 110 transmits AC power induced in the power transmission coil 112 to a power reception resonant circuit 210 by using the phenomenon of electromagnetic induction. In addition, in the present embodiment, the power transmission coil 112 is included in the coil unit 10.

The vehicle 200 may be, for example, a vehicle equipped with a drive motor, such as an electric vehicle or a hybrid vehicle. As shown in FIG. 1, the vehicle 200 includes the power receiver 205 and a battery 230. The power receiver 205 includes the power reception resonant circuit 210 and a power reception circuit 220. It should be noted that the vehicle 200 is not limited to an automobile, but may alternatively be, for example, a transport robot such as an AGV (Automatic Guided Vehicle) or an AMR (Autonomous Mobile Robot).

As shown in FIG. 2, the power reception resonant circuit 210 includes a reception-side capacitor 216 functioning as a resonance capacitor and a power reception coil 212. The power reception resonant circuit 210 may be arranged, for example, on a bottom surface of the vehicle 200. The power reception resonant circuit 210 receives from the power reception coil 212, the AC power induced in the power transmission resonant circuit 110 of the power transmitter 100.

The power reception circuit 220 converts the AC power outputted from the power reception resonant circuit 210 into DC power. The power reception circuit 220 may include, for example, a filter circuit, a rectifier circuit that converts the AC power into DC power, and a power conversion circuit that converts the DC power into DC power suitable for charging the battery 230. The battery 230 may be, for example, a secondary battery that outputs DC power for driving a drive motor of the vehicle 200. The DC power outputted from the power reception circuit 220 is used to charge the battery 230. In addition, the DC power outputted from the power reception circuit 220 may also be used for charging an auxiliary battery (not shown) and/or for driving the drive motor and/or auxiliary devices.

### A2. Configuration of Coil Unit 10

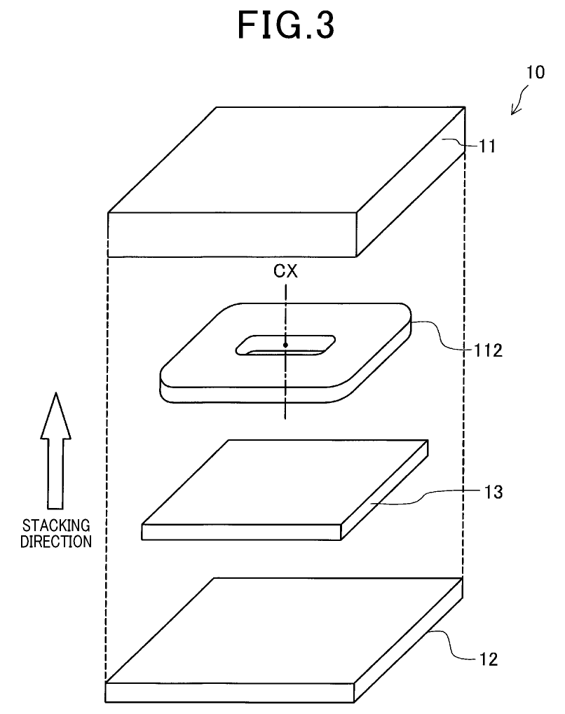

Next, the configuration of the coil unit 10 will be described with reference to FIG. 3. As shown in FIG. 3, the coil unit 10 includes a cover 11, an aluminum plate 12, a ferrite plate 13 and the power transmission coil 112. It should be noted that in FIG. 3, of the power transmission resonant circuit 110 and the power transmission circuit 120, only the power transmission coil 112 is illustrated omitting illustration of the other components. It also should be noted that the coil unit 10 may include any other members included in the power transmission resonant circuit 110, the power transmission circuit 120 and the power supply circuit 130.

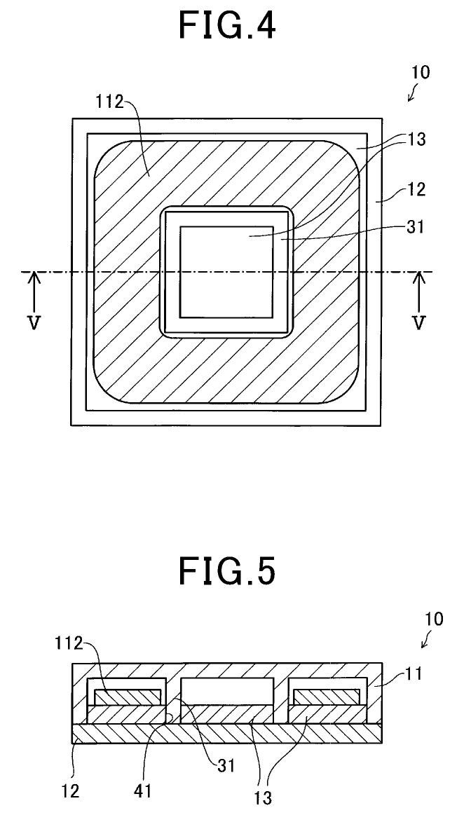

In addition, the coil unit 10 further includes a partition plate 31 (see FIG. 4). However, illustration of the partition plate 31 is omitted from FIG. 3; and the detailed configuration of the partition plate 31 will be described later with reference to FIGS. 4 and 5. Similarly, illustration of a through portion (or penetrated portion) 41 provided in the ferrite plate 13 is also omitted from FIG. 3.

The cover 11 is cup-shaped and has a rectangular outer shape in plan view. The cover 11 and the aluminum plate 12 are fitted together via a sealing member (not shown) to form a sealed space in which the power transmission coil 112, the ferrite plate 13 and the aluminum plate 12 are accommodated. As the sealing member, an O-ring, a liquid gasket or the like may be employed. In the sealed space, the ferrite plate 13 is placed on the aluminum plate 12; and the power transmission coil 112 is placed on the ferrite plate 13. In the following explanation, the direction in which the aluminum plate 12, the ferrite plate 13 and the power transmission coil 112 are stacked will be referred to as the “stacking direction”. Moreover, in a state where the cover 11 is located on the upper side, the surface of each component on the upper side in the stacking direction will be referred to as the “upper surface”; and the surface of each component on the lower side in the stacking direction will be referred to as the “lower surface”.

The cover 11, which is not electrically conductive, may be formed, for example, of a nonmagnetic material such as resin. Forming the cover 11 with a nonmagnetic material, blocking of magnetic flux generated from the power transmission coil 112 can be reduced or prevented. The upper surface of the cover 11 is that one of surfaces of the coil unit 10 which faces the power reception coil 212 of the vehicle 200. The lower surface of the cover 11 covers the upper surface of the power transmission coil 112, thereby protecting the power transmission coil 112 from outside air and the like. In the present embodiment, the cover 11 is embedded in the road RS; however, it may alternatively be exposed from the road RS.

The aluminum plate 12 has a rectangular outer shape in plan view. The aluminum plate 12 is provided such that the upper surface thereof abuts the lower surface of the ferrite plate 13. The aluminum plate 12 is formed of aluminum or an aluminum alloy. The aluminum plate 12 dissipates heat generated in the power transmission coil 112. Moreover, the aluminum plate 12 also has a shielding function such that it does not allow magnetic flux generated from the power transmission coil 112 to escape to the outside of the sealed space. It should be noted that instead of the aluminum plate 12, a plate of copper or other metals may be employed to constitute a plate member having both heat-dissipating and shielding functions. In addition, the aluminum plate 12 corresponds to a “base plate” in the present disclosure.

The ferrite plate 13 has a rectangular outer shape in plan view. The power transmission coil 112 is placed on the upper surface of the ferrite plate 13. In the present embodiment, the ferrite plate 13 is provided in such a manner as to abut the lower surface of the power transmission coil 112; however, the ferrite plate 13 may alternatively be provided in such a manner as to be separated from the lower surface of the power transmission coil 112. In addition, the ferrite plate 13 corresponds to a “magnetic plate” in the present disclosure. It should be noted that instead of the ferrite plate 13, a plate formed of a dust core or a nanocrystalline soft-magnetic material may be employed to constitute the magnetic plate.

In the present embodiment, the power transmission coil 112 is formed by winding an electrical conductor wire, such as a magnet wire, around a central axis CX. It should be noted that the power transmission coil 112 may alternatively be formed by resin-molding a magnet wire wound in a coil shape. It also should be noted that the power transmission coil 112 may alternatively be constituted of various types of coils such as a spiral coil formed by cutting an electrical conductor into a spiral shape, or a helical coil formed by helically winding an electrical conductor wire having a circular or rectangular cross section. In addition, in the case of the power transmission coil 112 being formed of an electrical conductor wire, the electrical conductor wire may be a stranded wire.

The power transmission coil 112 has, at a position including the central axis CX, a hollow region in which no electrical conductor is included. The central axis CX, which is a central axis of the coil unit 10, extends in an up-down direction through the centers of the aluminum plate 12, the ferrite plate 13 and the power transmission coil 112. In the present embodiment, the extending direction of the central axis CX is parallel to the stacking direction. That is, in the present embodiment, the power transmission coil 112 is formed by being wound in a direction intersecting the stacking direction.

Upon AC current flowing through the power transmission coil 112, magnetic flux is generated around the power transmission coil 112. The generated magnetic flux passes through the hollow region of the power transmission coil 112, the ferrite plate 13 and an outer peripheral side of the power transmission coil 112. Moreover, upon part of the magnetic flux generated around the power transmission coil 112 crossing the power reception coil 212, AC current flows through the power reception coil 212. Further, upon the AC current flowing through the power reception coil 212, magnetic flux is generated around the power reception coil 212. Through magnetic flux that crosses both the power transmission coil 112 and the power reception coil 212, the power reception coil 212 receives electric power from the power transmission coil 112 in a wireless (or contactless) manner.

In FIG. 4, for the sake of facilitating understanding, the individual members inside the cover 11 as viewed from the cover 11 side are illustrated omitting illustration of the cover 11. The partition plate 31 is provided in the cover 11. As shown in FIG. 4, the partition plate 31 has a ring shape whose outer edge has a rectangular shape in plain view. The partition plate 31 is arranged in the hollow region of the power transmission coil 112 that is indicated by hatching. Moreover, as shown in FIG. 5, in the present embodiment, the partition plate 31 extends from the lower surface of the cover 11 along the stacking direction and is formed integrally with the cover 11 into one piece. It should be noted that the partition plate 31 may alternatively be formed as a member separate from the cover 11.

As shown in FIG. 5, in the present embodiment, the ferrite plate 13 has the through portion (or penetrated portion) 41. In a state of the cover 11 and the aluminum plate 12 having been fitted together, an end portion of the partition plate 31 is inserted in the through portion 41 and abuts the aluminum plate 12. Consequently, when an external force is applied to the cover 11, the external force can be borne by the aluminum plate 12 via the partition plate 31, thereby suppressing deformation of the cover 11 due to the external force. Moreover, a distal end of the partition plate 31 in the stacking direction is inserted through the through portion 41 and thus does not abut against the ferrite plate 13. Consequently, it becomes possible to prevent the external force applied to the cover 11 from being transmitted to the ferrite plate 13; thus, it becomes possible to prevent the ferrite plate 13 from being deformed by the external force.

In the state of the cover 11 and the aluminum plate 12 having been fitted together, the partition plate 31 partitions the sealed space. Specifically, the partition plate 31 partitions the sealed space formed between the cover 11 and the aluminum plate 12 into a sealed space on a radially outer side of the partition plate 31 and a sealed space on a radially inner side of the partition plate 31. In the present embodiment, a fluid material is encapsulated in each of the plurality of sealed spaces partitioned by the partition plate 31. More particularly, in the present embodiment, oil is encapsulated as the fluid material. When the cover 11 is deformed by an external force applied thereto, the volume of the sealed space decreases, increasing the pressure of the fluid material within the sealed space; thus, a force acts from the inside of the cover 11 to resist the decrease in the volume of the sealed space. Consequently, deformation of the cover 11 due to the external force can be suppressed. Moreover, since the fluid material has fluidity, the external force applied to the cover 11 can be dispersed by the fluid material. Consequently, it becomes possible to prevent the external force from acting locally on the cover 11.

As described above, the coil unit 10 according to the present embodiment has the fluid material encapsulated in the sealed space. Therefore, when the cover 11 is deformed by an external force applied thereto, the volume of the sealed space decreases, increasing the pressure of the fluid material within the sealed space; thus, a force acts from the inside of the cover 11 to resist the decrease in the volume of the sealed space. Consequently, it becomes possible to suppress deformation of the cover 11 due to the external force while preventing the external force from being locally applied to the devices accommodated in the sealed space and thereby causing deformation of the devices.

Moreover, in the coil unit 10 according to the present embodiment, with the partition plate 31 provided in the cover 11, the pressure of the fluid material increased due to the external force applied to the cover 11 can be borne by the partition plate 31. Consequently, it becomes possible to suppress local concentration of the pressure on an outer edge portion of the cover 11.

Furthermore, in the coil unit 10 according to the present embodiment, the ferrite plate 13 has the through portion 41; and the partition plate 31 is inserted in the through portion 41 and thus does not abut against the ferrite plate 13. Consequently, it becomes possible to prevent the external force applied to the cover 11 from being transmitted to the ferrite plate 13; thus, it becomes possible to prevent the ferrite plate 13 from being deformed by the external force. In addition, the end portion of the partition plate 31 is inserted in the through portion 41 and abuts the aluminum plate 12. Consequently, when an external force is applied to the cover 11, the external force can be borne by the aluminum plate 12 via the partition plate 31, thereby suppressing deformation of the cover 11 due to the external force.

### B. Second Embodiment

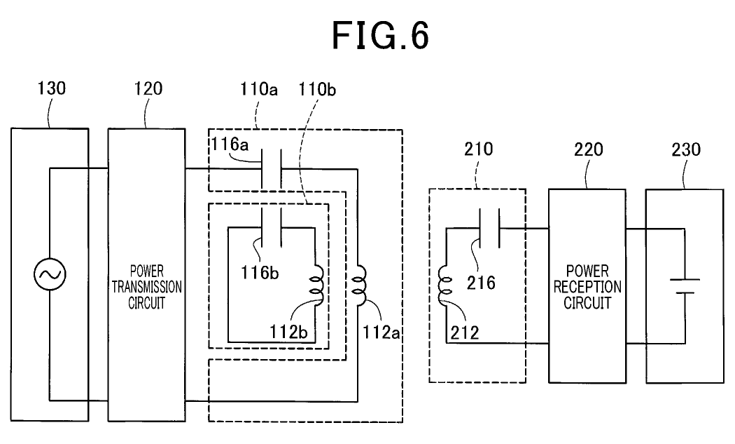

A coil unit 10A according to the second embodiment differs from the coil unit 10 according to the first embodiment in that as shown in FIGS. 6, 7 and 8, the coil unit 10A includes: a first power transmission resonant circuit 110a and a second power transmission resonant circuit 110b instead of the power transmission resonant circuit 110 included in the coil unit 10; a ferrite plate 13A instead of the ferrite plate 13 included in the coil unit 10; and partition plates 31a and 31b instead of the partition plate 31 included in the coil unit 10. Since the basic configuration of the coil unit 10A according to the second embodiment is the same as that of the coil unit 10 according to the first embodiment, identical components will be designated by the same reference signs and detailed descriptions of identical components will not be repeated.

The configurations of the first power transmission resonant circuit 110a and the second power transmission resonant circuit 110b will be described with reference to FIG. 6. The first power transmission resonant circuit 110a has a first power transmission coil 112a and a first power transmission-side capacitor 116a connected in series with each other. Similarly, the second power transmission resonant circuit 110b has a second power transmission coil 112b and a second power transmission-side capacitor 116b connected in series with each other. In addition, the first power transmission coil 112a corresponds to a “first coil” in the present disclosure; the first power transmission-side capacitor 116a corresponds to a “first capacitor” in the present disclosure; the second power transmission coil 112b corresponds to a “second coil” in the present disclosure; and the second power transmission-side capacitor 116b corresponds to a “second capacitor” in the present disclosure.

The first power transmission coil 112a of the first power transmission resonant circuit 110a and the second power transmission coil 112b of the second power transmission resonant circuit 110b are not electrically connected with each other. The first power transmission coil 112a, the first power transmission-side capacitor 116a, the second power transmission coil 112b and the second power transmission-side capacitor 116b are configured so that the resonance frequency of the first power transmission resonant circuit 110a and the resonance frequency of the second power transmission resonant circuit 110b are equal to each other. Setting the resonance frequency of the first power transmission resonant circuit 110a and the resonance frequency of the second power transmission resonant circuit 110b to be equal to each other, reactive power components of AC power in the first and second power transmission coils 112a and 112b can be suppressed, thereby suppressing decrease in the power transfer efficiency of the wireless power transfer system 300.

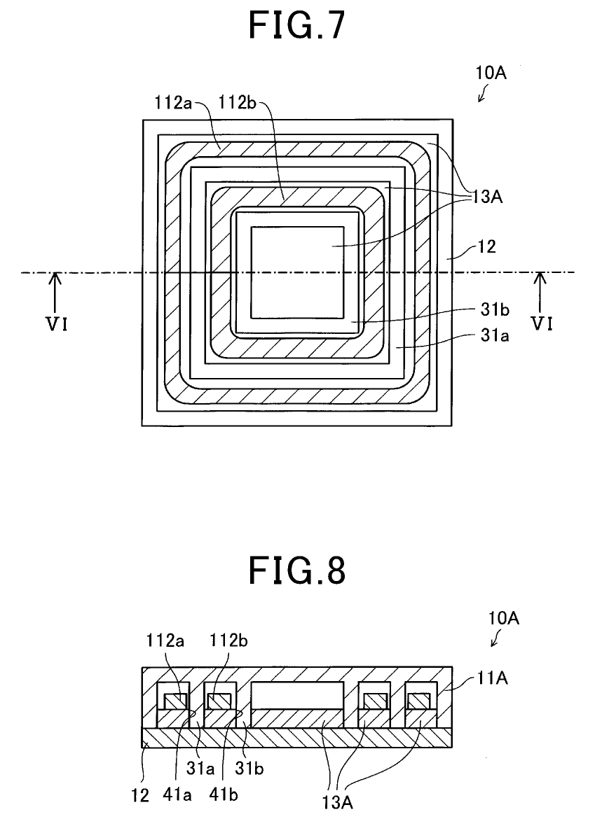

The configuration of the coil unit 10A according to the present embodiment will be described with reference to FIGS. 7 and 8. As shown in FIG. 7, the first power transmission coil 112a and the second power transmission coil 112b are arranged concentrically (or coaxially) with each other on the ferrite plate 13A, but not electrically connected with each other. It should be noted that in the present embodiment, the term “concentrically” does not necessarily require that the central axis CX of the first power transmission coil 112a and the central axis CX of the second power transmission coil 112b strictly coincide with each other. It also should be noted that the shape of the outer edge of each coil in plan view is not limited to a circular shape, but may alternatively be any ring shape.

As shown in FIG. 8, the ferrite plate 13A has through portions 41a and 41b. The through portion 41a is provided corresponding to a space formed in a radial gap between the first power transmission coil 112a and the second power transmission coil 112b. On the other hand, the through portion 41b is provided on a radially inner side of the second power transmission coil 112b.

As shown in FIG. 8, both the partition plates 31a and 31b extend from the lower surface of the cover 11A along the stacking direction and are formed integrally with the cover 11A into one piece. It should be noted that at least one of the partition plates 31a and 31b may alternatively be formed as a member separate from the cover 11A. In a state of the cover 11A and the aluminum plate 12 having been fitted together, an end portion of the partition plate 31b is inserted in the through portion 41b and abuts the aluminum plate 12; and an end portion of the partition plate 31a is inserted in both the radial gap between the first power transmission coil 112a and the second power transmission coil 112b and the through portion 41a, and abuts the aluminum plate 12. Therefore, when an external force is applied to the cover 11A, the external force can be borne by the aluminum plate 12 via both the partition plates 31a and 31b. Consequently, it becomes possible to more effectively suppress deformation of the cover 11A due to the external force as compared with a configuration in which the external force is borne by the aluminum plate 12 via, for example, only the partition plate 31a. Moreover, a distal end of the partition plate 31a is inserted through the radial gap between the first power transmission coil 112a and the second power transmission coil 112b and the through portion 41a and thus does not abut against any of the first power transmission coil 112a, the second power transmission coil 112b and the ferrite plate 13. Consequently, it becomes possible to prevent the external force applied to the cover 11A from being transmitted to any of the first power transmission coil 112a, the second power transmission coil 112b and the ferrite plate 13; thus, it becomes possible to prevent the aforementioned components from being deformed by the external force.

With the above-described coil unit 10A according to the second embodiment, it is possible to achieve the same advantageous effects as achievable with the coil unit 10 according to the first embodiment. Moreover, in the coil unit 10A according to the second embodiment, in the state of the cover 11A and the aluminum plate 12 having been fitted together, the end portion of the partition plate 31a is inserted in both the radial gap between the first power transmission coil 112a and the second power transmission coil 112b and the through portion 41a and abuts the aluminum plate 12. Therefore, when an external force is applied to that portion of the cover 11A which corresponds to the radial gap between the first power transmission coil 112a and the second power transmission coil 112b, the external force can be borne by the aluminum plate 12 via the partition plate 31a. Consequently, it becomes possible to more effectively suppress deformation of the cover 11A due to the external force.

Furthermore, in the coil unit 10A according to the second embodiment, the resonance frequency of the first power transmission resonant circuit 110a and the resonance frequency of the second power transmission resonant circuit 110b are set to be equal to each other. Consequently, it becomes possible to suppress the reactive power components of AC power in the first and second power transmission coils 112a and 112b, thereby suppressing decrease in the power transfer efficiency of the wireless power transfer system 300.

### C. Third Embodiment

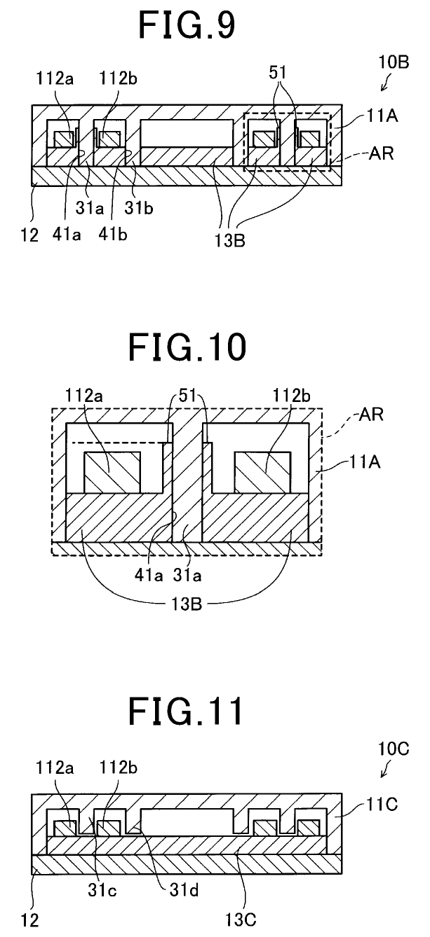

A coil unit 10B according to the third embodiment differs from the coil unit 10A according to the second embodiment in that as shown in FIGS. 9 and 10, the coil unit 10B includes a ferrite plate 13B instead of the ferrite plate 13A included in the coil unit 10A. Since the basic configuration of the coil unit 10B according to the third embodiment is the same as that of the coil unit 10A according to the second embodiment, identical components will be designated by the same reference signs and detailed descriptions of identical components will not be repeated. In addition, it should be noted that FIG. 10 shows, in a magnified manner, a region AR enclosed by a dashed line in FIG. 9.

As shown in FIGS. 9 and 10, the ferrite plate 13B has a protruding portion 51 that protrudes, from that surface of the ferrite plate 13B on which the first and second power transmission coils 112a and 112b are placed, along the partition plate 31a inserted in the through portion 41a of the ferrite plate 13B. With the configuration having the through portion 41a, the magnetic material becomes discontinuous at the through portion 41a and thus the magnetic reluctance thereof is increased so that the power transfer efficiency of the wireless power transfer system 300 is lowered as compared with a configuration having no through portion 41a. In this regard, in the present embodiment, with the protruding portion 51 provided in the ferrite plate 13B, the areas of those portions of the ferrite plate 13B which face each other in a direction perpendicular to the stacking direction via the partition plate 31a interposed therebetween are increased. Consequently, it becomes possible to suppress decrease in magnetic flux at the through portion 41a where the magnetic material becomes discontinuous; thus, it becomes possible to suppress increase in the magnetic reluctance of the ferrite plate 13B. As a result, it becomes possible to suppress decrease in the power transfer efficiency of the wireless power transfer system 300. In addition, in the present embodiment, in the state of the partition plate 31a having been inserted in the through portion 41a, the protruding portion 51 and the partition plate 31b are in contact with each other. Consequently, it becomes possible to minimize the facing distance between those portions of the ferrite plate 13B which face each other in the direction perpendicular to the stacking direction via the partition plate 31a interposed therebetween; thus, it becomes possible to further suppress increase in the magnetic reluctance of the ferrite plate 13B.

Moreover, as shown in FIG. 10, in the present embodiment, the dimension of the protruding portion 51 in the stacking direction is greater than the dimensions of the first and second power transmission coils 112a and 112b in the stacking direction. Consequently, it becomes easier for magnetic flux generated by electric current flowing through the first power transmission coil 112a to be guided to the protruding portion 51 that is magnetic in property; thus, it becomes possible to suppress eddy current loss occurring in the second power transmission coil 112b due to the magnetic flux passing through the second power transmission coil 112b. As a result, it becomes possible to suppress decrease in the power transfer efficiency of the wireless power transfer system 300.

With the above-described coil unit 10B according to the third embodiment, it is possible to achieve the same advantageous effects as achievable with the coil unit 10A according to the second embodiment. Moreover, in the coil unit 10B according to the third embodiment, the ferrite plate 13B has the protruding portion 51; therefore, the areas of those portions of the ferrite plate 13B which face each other in the direction perpendicular to the stacking direction via the partition plate 31a interposed therebetween are increased. Consequently, it becomes possible to suppress decrease in magnetic flux at the through portion 41a where the magnetic material becomes discontinuous; thus, it becomes possible to suppress increase in the magnetic reluctance of the ferrite plate 13B. As a result, it becomes possible to suppress decrease in the power transfer efficiency of the wireless power transfer system 300.

### D. Fourth Embodiment

A coil unit 10C according to the fourth embodiment differs from the coil unit 10A according to the second embodiment in that as shown in FIG. 11, the coil unit 10C includes: a cover 11C instead of the cover 11A included in the coil unit 10A; and a ferrite plate 13C instead of the ferrite plate 13A included in the coil unit 10A. Since the basic configuration of the coil unit 10C according to the fourth embodiment is the same as that of the coil unit 10A according to the second embodiment, identical components will be designated by the same reference signs and detailed descriptions of identical components will not be repeated.

In the present embodiment, the ferrite plate 13C is formed as a plate-shaped member having no through portion. With such a configuration, the ferrite plate 13C has no portion where the magnetic material becomes discontinuous. Consequently, it becomes possible to suppress increase in the magnetic reluctance of the ferrite plate 13C as compared with a configuration having a through portion.

Moreover, in the present embodiment, the cover 11C has partition plates 31c and 31d instead of the partition plates 31a and 31b included in the cover 11A according to the second embodiment. Both the partition plates 31c and 31d extend from the lower surface of the cover 11C along the stacking direction and are formed integrally with the cover 11C into one piece. Furthermore, in the present embodiment, end portions of the partition plates 31c and 31d are spaced apart from the ferrite plate 13C along the stacking direction. Consequently, when an external force is applied to the cover 11C, it is possible to prevent the external force from being transmitted to the ferrite plate 13C; thus, it becomes possible to prevent the ferrite plate 13C from being deformed by the external force. Moreover, with the partition plates 31c and 31d provided in the cover 11C, the pressure of the fluid material increased due to the external force applied to the cover 11C can be borne by the partition plates 31c and 31d. Consequently, it becomes possible to suppress local concentration of the pressure on an outer edge portion of the cover 11C. In addition, the flow path can be narrowed between distal ends of the partition plates 31c and 31d and the ferrite plate 13C, thereby suppressing flow of the fluid material between the spaces partitioned by the partition plates 31c and 31d.

The coil unit 10C according to the fourth embodiment has the fluid material encapsulated in the sealed space. Therefore, when the cover 11C is deformed by an external force applied thereto, the volume of the sealed space decreases, increasing the pressure of the fluid material within the sealed space; thus, a force acts from the inside of the cover 11C to resist the decrease in the volume of the sealed space. Consequently, it becomes possible to suppress deformation of the cover 11C due to the external force.

Moreover, in the coil unit 10C according to the fourth embodiment, with the partition plates 31c and 31d provided in the cover 11C, the pressure of the fluid material increased due to the external force applied to the cover 11C can be borne by the partition plates 31c and 31d. Consequently, it becomes possible to suppress local concentration of the pressure on the outer edge portion of the cover 11C. In addition, the flow path can be narrowed between the distal ends of the partition plates 31c and 31d and the ferrite plate 13C, thereby suppressing flow of the fluid material between the spaces partitioned by the partition plates 31c and 31d.

Furthermore, in the coil unit 10C according to the fourth embodiment, the end portions of the partition plates 31c and 31d are spaced apart from the ferrite plate 13C along the stacking direction. Consequently, when an external force is applied to the cover 11C, it is possible to prevent the external force from being transmitted to the ferrite plate 13C; thus, it becomes possible to prevent the ferrite plate 13C from being deformed by the external force.

### E. Fifth Embodiment

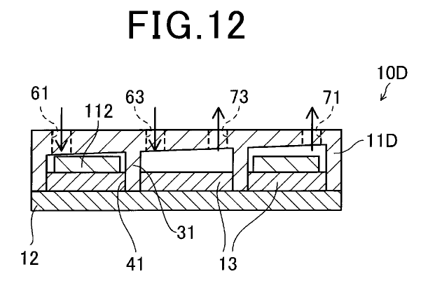

A coil unit 10D according to the fifth embodiment differs from the coil unit 10 according to the first embodiment in that as shown in FIG. 12, the coil unit 10D includes a cover 11D instead of the cover 11 included in the coil unit 10. Since the basic configuration of the coil unit 10D according to the fifth embodiment is the same as that of the coil unit 10 according to the first embodiment, identical components will be designated by the same reference signs and detailed descriptions of identical components will not be repeated.

The cover 11D has, at the time of manufacturing the coil unit 10D, an encapsulation inlet (or filling inlet) 61, a discharge outlet 71, an encapsulation inlet (or filling inlet) 63 and a discharge outlet 73. Both the encapsulation inlet 61 and the discharge outlet 71 are formed corresponding to the sealed space formed on the radially outer side of the partition plate 31, whereas both the encapsulation inlet 63 and the discharge outlet 73 are formed corresponding to the sealed space formed on the radially inner side of the partition plate 31. As above, in the case of the sealed space being partitioned into a plurality of sections by one or more partition plates, one pair of an encapsulation inlet and a discharge outlet is provided for each of the sections. All of the encapsulation inlet 61, the discharge outlet 71, the encapsulation inlet 63, and the discharge outlet 73 are sealed after the fluid material is encapsulated into the sealed space.

The encapsulation inlets 61 and 63, which fluidically connect the sealed space and the outside of the cover 11D, are used to encapsulate the fluid material into the sealed space. On the other hand, the discharge outlets 71 and 73, which also fluidically connect the sealed space and the outside of the cover 11D, are used to discharge air present in the sealed space during the encapsulation of the fluid material into the sealed space.

An inner surface of the cover 11D has a slope such that the dimension of the sealed space, which is formed when the cover 11D and the aluminum plate 12 are fitted together, in the stacking direction increases as the inner surface extends from the encapsulation inlet 61 toward the discharge outlet 71 and as the inner surface extends from the encapsulation inlet 63 toward the discharge outlet 73. Consequently, when filling the fluid material into the sealed space with the cover 11D located on the upper side of the aluminum plate 12, air present in the sealed space can be easily guided to the discharge outlet 71 that is located on the upper side of the encapsulation inlet 61 and to the outlet 73 that is located on the upper side of the encapsulation inlet 63; thus, it becomes possible to suppress the air from remaining in the sealed space.

With the above-described coil unit 10D according to the fifth embodiment, it is possible to achieve the same advantageous effects as achievable with the coil unit 10 according to the first embodiment. Moreover, in the coil unit 10D according to the fifth embodiment, the cover 11D further has the encapsulation inlet 61, the discharge outlet 71, the encapsulation inlet 63 and the discharge outlet 73. The inner surface of the cover 11D has a slope such that the dimension of the sealed space, which is formed when the cover 11D and the aluminum plate 12 are fitted together, in the stacking direction increases as the inner surface extends from the encapsulation inlet 61 toward the discharge outlet 71 and as the inner surface extends from the encapsulation inlet 63 toward the discharge outlet 73. Consequently, when filling the fluid material into the sealed space with the cover 11D located on the upper side of the aluminum plate 12, air present in the sealed space can be easily guided to the discharge outlets 71 and 73, thereby suppressing the air from remaining in the sealed space.

### F. Other Embodiments

In the above-described embodiments, the cover 11, the aluminum plate 12 and the ferrite plate 13 each have a rectangular outer shape in plain view; however, the present disclosure is not limited thereto. Alternatively, the cover 11, the aluminum plate 12 and the ferrite plate 13 each may have any outer shape, such as a trapezoidal or circular outer shape in plan view. Moreover, the power transmission coil 112 may be wound into any shape corresponding to the shapes of the cover 11, the aluminum plate 12 and the ferrite plate 13. Furthermore, the partition plate 31 may have any shape corresponding to the shape of the hollow region formed by the winding of the power transmission coil 112. With the above configurations, it is also possible to achieve the same advantageous effects as achievable according to the above-described embodiments.

In the above-described embodiments, the power transmission coil 112 is wound in a direction intersecting the stacking direction so that the central axis CX is parallel to the stacking direction; however, the present disclosure is not limited thereto. Alternatively, the power transmission coil 112 may be wound so that the central axis CX intersects with the stacking direction. With such a configuration, it is also possible to achieve the same advantageous effects as achievable according to the above-described embodiments.

In the above-described embodiments, the power transmission coil 112 is formed by winding an electrical conductor wire, such as a magnet wire, around the central axis CX; however, the present disclosure is not limited thereto. Alternatively, the power transmission coil 112 may be constituted of an electroconductive pattern formed on a printed circuit board. With such a configuration, it is also possible to achieve the same advantageous effects as achievable according to the above-described embodiments.

In the above-described embodiments, as the fluid material, oil is encapsulated in the sealed space; however, the present disclosure is not limited thereto. Alternatively, the fluid material may be any material that has fluidity, such as a gas, liquid, powder or gel. It is preferable that the fluid material be a material having a higher density than air under standard conditions; this is because in this case, the resistance of the fluid material to the volume compression would be higher than that in the case of the fluid material being a material having a lower density than air under standard conditions. In addition, a mixture of a liquid and a powder may be employed as the fluid material.

It is preferable that the fluid material be a material having a higher viscosity than water; this is because in this case, the resistance is high when the fluid material flows within the sealed space under the application of an external force thereto. In addition, most of external forces applied to the coil unit 10 are instantaneous loads applied, for example, when the vehicle 200 drives over and passes above the power transmission coil 112. Therefore, the fluid material is not limited to a material whose viscosity is constantly high, but may be a material whose viscosity temporarily increases when an external force is instantaneously applied thereto. More particularly, a dilatant fluid may be employed as the fluid material.

The lower the thermal resistance of the fluid material, the easier it is for the fluid material to dissipate heat generated in the power transmission coil 112. Moreover, the higher the electrical insulation properties of the fluid material, the more effectively leakage current from the power transmission coil 112 can be suppressed and thus the more effectively decrease in the power transfer efficiency of the wireless power transfer system 300 can be suppressed. Furthermore, the resistance of the fluid material to deformation of the cover 11 can be increased by applying higher pressure when filling the fluid material into the sealed space. In addition, the higher the viscosity of the fluid material, the more effectively leakage of the fluid material from the sealed space can be suppressed and thus the more effectively the resistance of the fluid material to decrease in the volume of the sealed space can be prevented from being lowered due to the leakage of the fluid material from the sealed space.

In the above-described embodiments, the coil unit 10 is provided in the power transmitter 100; however, the present disclosure is not limited thereto. Alternatively, the coil unit 10 may be provided in the vehicle 200.

In the second embodiment described above, the first power transmission coil 112a and the first power transmission-side capacitor 116a are connected in series with each other and the second power transmission coil 112b and the second power transmission-side capacitor 116b are connected in series with each other; however, the present disclosure is not limited thereto. Alternatively, the first power transmission coil 112a and the first power transmission-side capacitor 116a may be connected in parallel with each other; and the second power transmission coil 112b and the second power transmission-side capacitor 116b may be connected in parallel with each other. With such a configuration, it is also possible to achieve the same advantageous effects as achievable according to the second embodiment.

In the third embodiment described above, in the state of the partition plate 31a having been inserted in the through portion 41a, the protruding portion 51 and the partition plate 31b are in contact with each other; however, the present disclosure is not limited thereto. Alternatively, a gap may be provided between the protruding portion 51 and the partition plate 31b. With such a configuration, it is also possible to achieve the same advantageous effects as achievable according to the third embodiment. In addition, with a gap provided between the protruding portion 51 and the partition plate 31b, the insertion of the partition plate 31b into the protruding portion 51 and the through portion 41a can be facilitated.

In the fourth embodiment described above, the coil unit 10C has both the first power transmission coil 112a and the second power transmission coil 112b; however, the present disclosure is not limited thereto. As in the first embodiment, the coil unit 10C may have a single power transmission coil 112; and the partition plate 31c may be provided so that the end portion of the partition plate 31c is spaced apart from the power transmission coil 112 along the stacking direction. With such a configuration, it is also possible to prevent an external force applied to the cover 11C from being transmitted to the power transmission coil 112 and causing deformation of the power transmission coil 112. In addition, it becomes unnecessary to divide the coil in order to avoid contact between the partition plate 31c and the coil; thus, it becomes possible to prevent the configuration of the coil from becoming complicated.

Furthermore, either the partition plate 31c or the partition plate 31d may be provided in contact with the power transmission coil 112 or the ferrite plate 13C. With such a configuration, it is possible to suppress deformation of the power transmission coil 112 or the ferrite plate 13C due to an external force applied to the cover 11C as compared with the case of providing both the partition plate 31c and the partition plate 31d in contact with the power transmission coil 112 or the ferrite plate 13C.

In the above-described embodiments, the coil unit 10 includes the partition plate 31; however, the present disclosure is not limited thereto. The coil unit 10 may not include the partition plate 31. Even with such a configuration, since the coil unit 10 has the fluid material encapsulated in the sealed space, when the cover 11 is deformed by an external force applied thereto, the volume of the sealed space decreases, increasing the pressure of the fluid material within the sealed space; thus, a force acts from the inside of the cover 11 to resist the decrease in the volume of the sealed space. Consequently, it will become possible to suppress deformation of the cover 11 due to the external force while preventing the external force from being locally applied to the devices accommodated in the sealed space and thereby causing deformation of the devices.

While the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

The following notes summarize the technical features derived from the present disclosure.

### First Note

A coil unit (10, 10A, 10B, 10C, 10D) for use in a wireless power transfer system (300), the coil unit comprising: a base plate (12); a cover (11, 11A, 11C, 11D) that forms a sealed space between the cover and the base plate; a magnetic plate (13, 13A, 13B, 13C) placed on the base plate within the sealed space; a coil (112, 212) configured to transmit or receive AC power, the coil being placed on the magnetic plate in a stacking direction within the sealed space, the stacking direction being a direction in which the base plate, the magnetic plate and the coil are stacked; and a fluid material having fluidity and encapsulated in the sealed space.

### Second Note

The coil unit according to the first note, wherein the fluid material has a density higher than that of air under standard conditions.

### Third Note

The coil unit according to the first or second note, further comprising a partition plate (31, 31a, 31b, 31c, 31d) extending along the stacking direction within the sealed space.

### Fourth Note

The coil unit according to the third note, wherein: the magnetic plate has a through portion (41, 41a, 41b) in which the partition plate is inserted; and the partition plate has an end portion inserted in the through portion of the magnetic plate and abutting the base plate to partition the sealed space.

### Fifth Note

The coil unit according to the fourth note, wherein: the coil comprises a first coil (112a) and a second coil (112b) that are arranged concentrically with each other, and not electrically connected with each other; the through portion (41a) of the magnetic plate is provided corresponding to a space formed in a radial gap between the first coil and the second coil; and the partition plate (31a) is inserted in both the radial gap between the first coil and the second coil and the through portion of the magnetic plate, and abuts the base plate.

### Sixth Note

The coil unit according to the fifth note, further comprising: a first power transmission resonant circuit (110a) that includes the first coil and a first capacitor (116a); and a second power transmission resonant circuit(110b) that includes the second coil and a second capacitor (116b), wherein a resonance frequency of the first power transmission resonant circuit and a resonance frequency of the second power transmission resonant circuit are equal to each other.

### Seventh Note

The coil unit as set forth in any one of the fourth to sixth notes, wherein the magnetic plate has a protruding portion (51) that protrudes, from a surface of the magnetic plate on which the coil is placed, along the partition plate inserted in the through portion of the magnetic plate.

### Eighth Note

The coil unit according to the third note, wherein an end portion of the partition plate (31c, 31d) is spaced apart from at least one of the magnetic plate and the coil along the stacking direction.

### Ninth Note

The coil unit according to the first to eighth notes, wherein: the cover (11D) has an encapsulation inlet (61, 63) fluidically connecting the sealed space and an outside of the cover and used to encapsulate the fluid material into the sealed space, and a discharge outlet (71, 73) fluidically connecting the sealed space and the outside of the cover and used to discharge air present in the sealed space during the encapsulation of the fluid material into the sealed space; and an inner surface of the cover has a slope such that a dimension of the sealed space in the stacking direction increases as the inner surface extends from the encapsulation inlet toward the discharge outlet.

What is claimed is:

1. A coil unit for use in a wireless power transfer system, the coil unit comprising:
a base plate;
a cover that forms a sealed space between the cover and the base plate;
a magnetic plate placed on the base plate within the sealed space;
a coil configured to transmit or receive AC power, the coil being placed on the magnetic plate in a stacking direction within the sealed space, the stacking direction being a direction in which the base plate, the magnetic plate and the coil are stacked; and
a fluid material having fluidity and encapsulated in the sealed space.

2. The coil unit as set forth in claim 1, wherein the fluid material has a density higher than that of air under standard conditions.

3. The coil unit as set forth in claim 1, further comprising a partition plate extending along the stacking direction within the sealed space.

4. The coil unit as set forth in claim 3, wherein:
the magnetic plate has a through portion in which the partition plate is inserted; and
the partition plate has an end portion inserted in the through portion of the magnetic plate and abutting the base plate to partition the sealed space.

5. The coil unit as set forth in claim 4, wherein:
the coil comprises a first coil and a second coil that are arranged concentrically with each other, and not electrically connected with each other;
the through portion of the magnetic plate is provided corresponding to a space formed in a radial gap between the first coil and the second coil; and
the partition plate is inserted in both the radial gap between the first coil and the second coil and the through portion of the magnetic plate, and abuts the base plate.

6. The coil unit as set forth in claim 5, further comprising:
a first power transmission resonant circuit that includes the first coil and a first capacitor; and
a second power transmission resonant circuit that includes the second coil and a second capacitor,
wherein
a resonance frequency of the first power transmission resonant circuit and a resonance frequency of the second power transmission resonant circuit are equal to each other.

7. The coil unit as set forth in claim 4, wherein the magnetic plate has a protruding portion that protrudes, from a surface of the magnetic plate on which the coil is placed, along the partition plate inserted in the through portion of the magnetic plate.

8. The coil unit as set forth in claim 3, wherein an end portion of the partition plate is spaced apart from at least one of the magnetic plate and the coil along the stacking direction.

9. The coil unit as set forth in claim 1, wherein:
the cover has
an encapsulation inlet fluidically connecting the sealed space and an outside of the cover and used to encapsulate the fluid material into the sealed space, and
a discharge outlet fluidically connecting the sealed space and the outside of the cover and used to discharge air present in the sealed space during the encapsulation of the fluid material into the sealed space; and
an inner surface of the cover has a slope such that a dimension of the sealed space in the stacking direction increases as the inner surface extends from the encapsulation inlet toward the discharge outlet.
